(19) United States
(12) Patent Application Publication
(10) Pub. No.: US 2005/0064118 A1
(43) Pub. Date: Mar. 24, 2005

(54) Gel for creating a coating for extruded sausage comprised of starch and an edible vegetable based material

(76) Inventor: Robert W. Damstetter, Des Moines, IA (US)

Correspondence Address: NATIONAL STARCH AND CHEMICAL COMPANY, P.O. BOX 6500, BRIDGEWATER, NJ, 08807-3300, US

(21) Appl. No.: 10/495,763

(22) PCT Filed: Nov. 13, 2002
(86) PCT No.: PCT/US02/36311

Related U.S. Application Data
(60) Provisional application No. 60/333,243, filed on Nov. 14, 2001.
(60) Provisional application No. 60/373,060, filed on Apr. 16, 2002.

(51) Int. Cl. A22C 13/00

(52) U.S. Cl. 428/34.8

(57) ABSTRACT

A method of making a sausage product involves creating a coating composition comprised substantially of starch; making a sausage product by extruding a sausage strand of meat emulsion with the coating composition; and curing the coating composition to create an edible structurally stable sausage product comprised of the sausage strand of meat emulsion with a thin layer of the edible coating composition. The resulting sausage product can have a layer of edible cured material on an outer surface of the meat emulsion comprised of a mixture of starch and an edible vegetable based material. The composition of the edible casing is comprised of a mixture of starch and an edible vegetable based material, or of starch alone, or of a combination of both.

### FIELD OF THE INVENTION

The present invention relates to sausage production using coextrusion with a collagen gel as the casing forming material. The invention more specifically relates to an improved casing material for the coextrusion process.

### BACKGROUND OF THE INVENTION

In sausage production, coextrusion has recently gained importance. Instead of filling sausage casings, the method of coextrusion makes a casing while filling it with meat. In this process the casing is formed from a gel. Heretofore, the preferred and principal gel material was animal derived collagen. This material has the advantage that it can form a good casing film and it is edible. The drawback is that it is expensive. It has the appearance and taste of a natural casing. One drawback is that it is expensive and requires significant processing. Another drawback is that there are a number of products which may otherwise be produced by this method that are required to be animal-product free (for example soy sausage). Experiments to form a casing comprised of a starch product to replace all or a significant percentage of animal-derived collagen have not been successful prior to this invention because the shear modulus (G) has not been as high as with animal-derived collagen alone. It is necessary to reach a G of over 600 Pa in order to get a casing film strong enough to replace the traditional product.

It is therefore a principal object of this invention to provide a gel for sausage casings that is edible and inexpensive, and capable of being used with all sausage types, and is capable of creating a strong stable coating which can be easily dried or cured, and which is comprised essentially of starch, or starch in combination with collagen or other suitable edible material such as vegetable material.

### SUMMARY OF INVENTION

A method of making a sausage product involves creating a coating composition comprised substantially of starch; making a sausage product by extruding a sausage strand of meat emulsion with the coating composition; and curing the coating composition to create an edible structurally stable sausage product comprised of the sausage strand of meat emulsion with a thin layer of the edible coating composition. The resulting sausage product can have a layer of edible cured material on an outer surface of the meat emulsion comprised of a mixture of starch and an edible vegetable based material. The composition of the edible casing is comprised of a mixture of starch and an edible vegetable based material, or of starch alone, or of a combination of both.

### DESCRIPTION OF THE PREFERRED EMBODIMENT

A thermoplastic starch slurry is added to a conventional collagen gel. The starch slurry is comprised of approximately one part dry starch and nine parts water, by weight. The slurry is thoroughly mixed with the collagen in proportions of approximately ten parts slurry and forty parts collagen, by weight under chilled conditions. The slurry may have been previously cooked to enhance its cross-linking properties.

Starch preparation may consist of mixing in water alone or require a pre-cooking step. This preparation is required to begin the cross-linking of the starch. A cross-link joins two polymer molecules together. If there are many cross-links in a material, it will form a continuous network such as a gel or an elastomer. Entanglements may act as temporary or transient cross-links but it is normal to use chemical reactions to produce covalent bonds in order to make elastomers.

There are two important concepts in casings, shear modulus and Young's modulus. Shear modulus, G, is the elastic constant of a material that describes the relationship between shear stress, σ_{g} and shear strain, γ.
G=σ_{g}/γ.

Young's modulus, E, is the elastic constant of a material that describes the relationship between elongational stress, σₑ and elongational strain γ.
E=σₑ/γ.

Both of these moduli have to be upwards of 600 in order for the sausages to withstand mechanical formation, curing, and packaging.

Tests have shown that the sausages produced are very similar to straight collagen gel produced sausages. The starch addition lowers the cost of the mixture since more expensive collagen is replaced by less expensive starch. A cost comparison appears below:

| | |
|---|---|
| Cost of collagen: | $1.34/lb. |
| Cost of starch: | 0.10/lb. |
| Combined cost: | 1.07/lb. |
| Cost savings: | .27/lb. |

Testing indicates that any desired thermoplastic starch can be used. The starch does not only act as a filler but as a film former also.

Typical edible starches capable of use in this invention are set forth in EP 0 547 551 B1 which is incorporated here by reference. Such starch products which can be used on a sausage coextrusion machine are disclosed in the following patents:

| | | | |
|---|---|---|---|
| 5,759,602 | 6,024,637 | 5,888,131 | 5,843,504 |
| 6,054,155 | 5,887,919 | 6,290,590 | 5,938,520 |
| 6,153,234 | 5,951,390 | 6,245,369 | 6,234,891 |
| 5,989,609 | 6,013,295 | 6,331,104 | |

Extrusion using a coating layer primarily of starch is possible because, in addition to being edible, starch has substantial film forming capabilities.

While the foregoing is especially suitable for coextrusion processes, the use of starch is also desirable to comprise shirred casings as well. Starch alone is desirable, but starch as an extender for collagen or other edible material such as a vegetable-based edible material at the rate of 10% or more by weight of starch is also desirable. A suitable vegetable-based material is algae.

Experiments to form a casing comprised of a starch product to replace all or a significant percentage of animal-derived collagen have not been successful prior to this invention because the shear modulus (G) has not been as high as with animal-derived collagen alone. It is necessary to reach a G of over 600 Pa in order to get a casing film strong enough to replace the traditional product.

One of the advantages for adding starch to collagen is that the addition of a type of starch in its prepared state (similar in consistency to gravy) to the collagen lowers the viscosity level of collagen. This causes the mixture to pump more smoothly and at a reduced pressure level. This relieves some of the enormous pressure on the seals within the extruder while still creating a good film (or casing) on the product.

Further benefit of adding starch to collagen is that some starches have a property of shear thinning (pseudoplasticity). Their viscosity rate falls as shear rate increases. A relatively viscous starch product that gets more liquid as the pressure increases and then thickens up when the pressure is released (after the extrusion) will result.

It is therefore seen that this invention will achieve at least all of its stated objectives.

1. A method of coextruding a sausage product, comprising, creating a slurry of starch and water, combining the slurry with a collagen gel to create a coating composition comprised of collagen and starch, and coextruding a sausage product by coating a sausage strand of meat emulsion with the coating composition, and curing the coating composition to create an edible structurally stable sausage product comprised of the sausage strand of meat emulsion with a thin layer of the edible coating composition.

2. The method of claim 1 wherein the coating composition comprises at least 10% by weight of the starch.

3. The method of claim 1 wherein the slurry has a ratio of starch and water by weight of one to nine.

4. The method of claim 1, wherein the coating composition has approximately 10 parts slurry to 40 parts collagen gel.

5. The method of claim 1 wherein the starch is thermoplastic starch.

6. A method of making a sausage product, comprising, creating a coating composition comprised substantially of starch, and making a sausage product by extruding a sausage strand of meat emulsion with a coating composition comprised substantially of starch, and curing the coating composition to create an edible structurally stable sausage product comprised of the sausage strand of meat emulsion with a thin layer of the edible coating composition.

7. The method of claim 6 wherein the starch is a mixture of dry starch and water.

8. The method of claim 7 wherein the ratio of starch and water by weight is one to nine.

9. The method of claim 6 wherein the starch is thermoplastic starch.

10. The method of claim 6 wherein the thin layer of edible coating composition is an extended shirred casing.

11. An extruded sausage product, comprising, an elongated center strand of meat emulsion, a layer of edible cured material on an outer surface of the meat emulsion comprised of a mixture of starch and an edible vegetable based material.

12. The sausage product of claim 11 wherein the layer of edible cured material comprises at least 10% by weight of starch.

13. The sausage product of claim 12 wherein the starch is comprised of a mixture of dry starch and water.

14. The product of claim 11 wherein the starch is thermoplastic starch.

15. The product of claim 11 wherein the layer of edible cured material is an extended shirred casing.

16. An extruded sausage product, comprising, an elongated center strand of meat emulsion, a layer of edible cured material on an outer surface of the meat emulsion comprised primarily of a cured mixture of starch and water.

17. A composition for use in creating an edible outer coating for an extruded sausage, comprised of a mixture of starch and an edible vegetable based material.

18. The composition of claim 17 wherein the mixture comprises at least 10% by weight of starch.

19. The composition of claim 17 wherein the starch is comprised of a mixture of dry starch and water.

20. The composition of claim 19 wherein the ratio by weight of starch and water is approximately 1 to 9.

21. The method of claim 17 wherein the starch is thermoplastic starch.

22. A shirred casing material for receiving a strand of sausage material wherein the casing material is comprised of starch.

23. A method of making a sausage product, comprising creating a slurry of starch and water, combining the slurry with an edible vegetable based material to create a coating composition, coextruding a sausage product by coating a sausage strand of meat emulsion with the coating composition, and curing the coating composition to create an edible structurally stable sausage product comprised of the sausage strand of meat emulsion with a thin layer of the edible coating composition.

24. The method of claim 23 wherein the slurry has a ratio of starch to water by weight of one to nine.
